(19) United States
(12) Patent Application Publication
(10) Pub. No.: US 2022/0245695 A1
(43) Pub. Date: Aug. 4, 2022

(54) CONFIGURATION GENERATION METHOD AND APPARATUS, AND STORAGE MEDIUM

(71) Applicant: SHENZHEN SENSETIME TECHNOLOGY CO., LTD., Shenzhen (CN)

(72) Inventor: Peixiong HUANG, Shenzhen (CN)

(21) Appl. No.: 17/726,820

(22) Filed: Apr. 22, 2022

Related U.S. Application Data
(63) Continuation of application No. PCT/CN2021/088928, filed on Apr. 22, 2021.

(30) Foreign Application Priority Data
Sep. 29, 2020 (CN) 202011049483.6

(51) Int. Cl. G06Q 30/06

(52) U.S. Cl. CPC G06Q 30/0621

(57) ABSTRACT

A configuration generation method and apparatus and a storage medium are provided. The method includes that: first service information is received, the first service information including first information for describing a first service scenario and at least one service function, and the first service scenario being a scenario where the at least one service function is applied; and a target product configuration list is generated based on the first service information and a target product performance index, the target product performance index including the performance index of a target product that implements the at least one service function under the first service scenario, and the target product configuration list including at least one of the number of the target products, the software configuration of the target products and the hardware configuration of the target products.

### CROSS-REFERENCE TO RELATED APPLICATION

The disclosure is a continuation application of International Patent Application No. PCT/CN2021/088928, filed on Apr. 22, 2021, which is based upon and claims priority to Chinese Patent Application No. 202011049483.6, filed on Sep. 29, 2020, the disclosure of which is hereby incorporated by reference in its entirety.

### BACKGROUND

Artificial Intelligence (AI) is a new technical science that researches and develops theories, methods, technologies and application systems for simulating, extending and expanding human intelligence. AI is a branch of computer science, which attempts to understand the essence of intelligence and produce a new intelligent machine that can respond in a similar way to human intelligence. The research in this field includes robots, language recognition, image recognition, natural language processing, expert systems, and the like.

In various AI application scenarios, customers' cognition of AI products is usually limited to what problems the products can help to solve, such as monitoring of illegal parking, garbage dumping and other problems, but they do not know the hardware and software configurations that the AI products need to meet when applied to different service scenarios.

### SUMMARY

The disclosure relates to the technical field of computers, in particular to a configuration generation method and apparatus, an electronic device and a storage medium.

Embodiments of the disclosure disclose a configuration generation method and apparatus, an electronic device and a storage medium, which can solve the problem of software and hardware configurations that AI products need to meet when applied to different service scenarios, and are convenient to operate and short in time.

According to a first aspect, the embodiments of the present disclosure provide a configuration generation method, which includes that: first service information is received, the first service information including first information for describing a first service scenario and at least one service function, and the first service scenario being a scenario where the at least one service function is applied; and a target product configuration list is generated based on the first service information and a target product performance index, the target product performance index including the performance index of the target product that implements the at least one service function under the first service scenario, and the target product configuration list including at least one of the number of the target products, the software configuration of the target products and the hardware configuration of the target products.

According to a second aspect, the embodiments of the present disclosure provide a configuration generation apparatus, which may include: an input circuit configured to receive first service information, the first service information including first information for describing a first service scenario and at least one service function, and the first service scenario being a scenario where the at least one service function is applied; and a processing circuit configured to generate a target product configuration list based on the first service information and a target product performance index, the target product performance index including the performance index of the target product that implements the at least one service function under the first service scenario, and the target product configuration list including at least one of the number of the target products, the software configuration of the target products and the hardware configuration of the target products.

According to a third aspect, the embodiments of the present disclosure provide a computer readable storage medium. The computer storage medium stores a computer program thereon. The computer program may include a program instruction. When executed by a processor, the program instruction causes the processor to execute a configuration generation method, which includes that: first service information is received, the first service information including first information for describing a first service scenario and at least one service function, and the first service scenario being a scenario where the at least one service function is applied; and a target product configuration list is generated based on the first service information and a target product performance index, the target product performance index including the performance index of the target product that implements the at least one service function under the first service scenario, and the target product configuration list including at least one of the number of the target products, the software configuration of the target products and the hardware configuration of the target products.

### BRIEF DESCRIPTION OF THE DRAWINGS

In order to describe the technical solutions in the embodiments of the present disclosure or in background more clearly, descriptions on the accompanying drawings which are needed in the embodiments of the present disclosure or background are given below.

FIG. 1 is a flowchart of a configuration generation method according to an embodiment of the disclosure.

FIG. 2A is a schematic diagram of a first product input page according to an embodiment of the disclosure.

FIG. 2B is a sample diagram of a first product input page according to an embodiment of the disclosure.

FIG. 2C is a sample diagram of another first product input page according to an embodiment of the disclosure.

FIG. 3 is a flowchart of another configuration generation method according to an embodiment of the disclosure.

FIG. 4 is a diagram of correspondences between services and product configuration list conversion formulas according to an embodiment of the disclosure.

FIG. 5 is a flowchart of a method for configuring a product configuration list conversion formula according to an embodiment of the disclosure.

FIG. 6 is a flowchart of another configuration generation method according to an embodiment of the disclosure.

FIG. 7 is a flowchart of another configuration generation method according to an embodiment of the disclosure.

FIG. 8 is a structural schematic diagram of a configuration generation apparatus according to an embodiment of the disclosure.

FIG. 9 is a structural schematic diagram of a server according to an embodiment of the disclosure.

FIG. 10 is a structural schematic diagram of a terminal device according to an embodiment of the disclosure.

### DETAILED DESCRIPTION

Terms such as “first”, “second” and “third” in the embodiments of the specification, claims and accompanying drawings of the present disclosure are only used to distinguish similar objects, rather than to describe a special order or a precedence order. In addition, the terms “comprising,” “having” or any other variation thereof, are intended to cover a non-exclusive inclusion. For example, a method, system, product or device that includes a list of steps or units is not necessarily limited to only those steps or units but may include other steps or units not expressly listed or inherent to such method, product or device.

In a related art, since a customer does not know the software and hardware configurations that AI products need to meet when applied to different service scenarios, it is necessary to study how to solve the problem of the software and hardware configurations that the AI products need to meet when applied to different service scenarios. The embodiments of the disclosure provide a configuration generation method, which can generate a product configuration list for services in various service scenarios. A brief introduction is given below to the applicable scenarios of the configuration generation method provided by the embodiments of the present disclosure.

Scenario 1: a user receives first service information from the user through software running on a terminal device (such as a personal computer); a target product configuration list is generated based on the first service information and a product performance index; and the target product configuration list is output. The user only needs to input information describing a first service and information describing a first service scenario to be applied by the first service (i.e., the first service information), and does not need to know the requirements of the services in different application scenarios for the software and hardware configurations of a product.

Scenario 2: the user receives the first service information from the user through the software running on the terminal device (such as the personal computer) or a login web page; the terminal device uploads the first service information to a server; the server generates the target product configuration list based on the first service information and the product performance index; the server sends the target product configuration list to the terminal device; and the terminal device outputs (for example, displays through a display) the target product configuration list.

In the above scenarios, by implementing the configuration generation method provided by the embodiments of the present disclosure, the user can obtain the product configuration list by inputting service information, so that operation is simple.

The configuration generation method provided by the embodiments of the present disclosure will be described below with reference to the drawings.

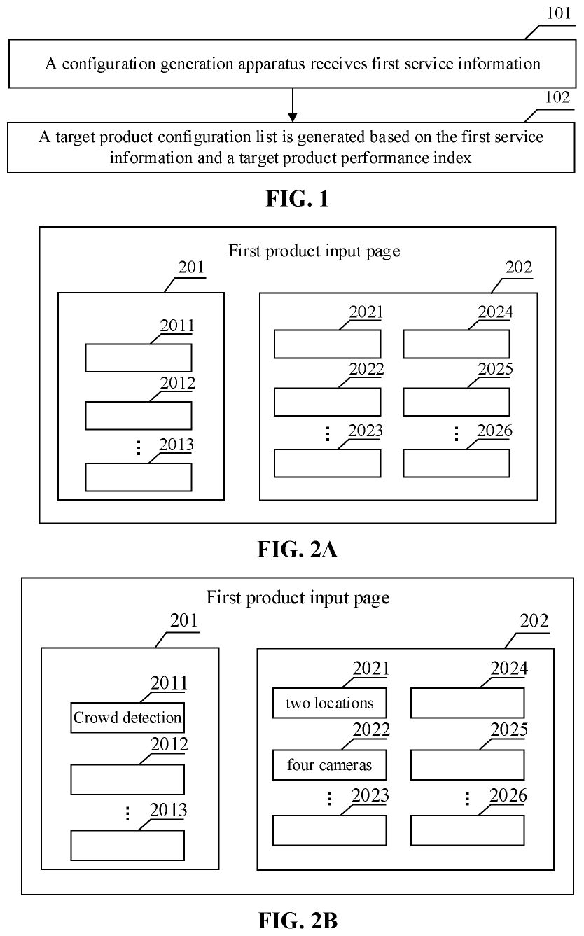

Referring to FIG. 1, FIG. 1 is a flowchart of a configuration generation method according to an embodiment of the disclosure. As illustrated in FIG. 1, the method may include the following operations.

At 101, a configuration generation apparatus receives first service information.

The first service information includes first information for describing a first service scenario and at least one service function, and the first service scenario is a scenario where the at least one service function is applied. The configuration generation apparatus may be a terminal device such as a mobile phone, a tablet computer, a laptop computer or a desktop computer, and may also be a server (such as a cloud server). The first service scenario may be an AI application scenario, such as monitoring of illegal parking, garbage dumping, and fighting or other application scenarios. The target product may be an AI product, such as a product with a garbage detection function and a product with a crowd density detection function. The information for describing the first service scenario may be understood as scenario input information. For example, the first service scenario is an urban management scenario, and the first service information may include: population quantity, a fighting detection function and the number of cameras. The fighting detection function is a service function (corresponding to the at least one service function), and the population quantity and the number of cameras are information for describing the first service scenario (i.e., scenario input information). For another example, the first service scenario is a crowd detection scenario, and the first service information may include: a crowd detection function, two locations and four cameras. The crowd detection function is a service function, and the two locations and four cameras are information for describing the first service scenario (i.e., the scenario input information). For another example, the first service scenario is an urban management scenario, and the first service information may include: a fighting detection function, a crowd detection function, two locations and four cameras. The crowd detection function and the fighting detection function are service functions, and the two locations and four cameras are information for describing the first service scenario (i.e., the scenario input information).

In some embodiments, before performing operation 101, the configuration generation apparatus may display a first product input page in response to an instruction that the user selects the first service scenario from multiple service scenarios, each of the multiple service scenarios corresponding to a product input page, and the product input pages corresponding to different service scenarios in the multiple service scenarios being different. In a possible implementation at operation 101 below, the first service information filled in the first product input page by the user is received. The first product input page may be understood as a scenario input page specially configured for the first service scenario. That is to say, the first product input page is specially configured to implement a scenario configuration required by a customer, so that the user can input scenario information conveniently (such as information describing the first service scenario). It is to be understood that the user's cognition for the AI products is merely limited to what problems the products can help to solve, and it is not easy to know the requirements of the services under different application scenarios for the software and hardware configurations of the product. In this implementation, the user may conveniently input the information for describing the first application scenario through the first product input page, and does not need to know the requirements of the services under different application scenarios for the software and hardware configurations of the product, which can reduce the requirements on the user and improve the user experience.

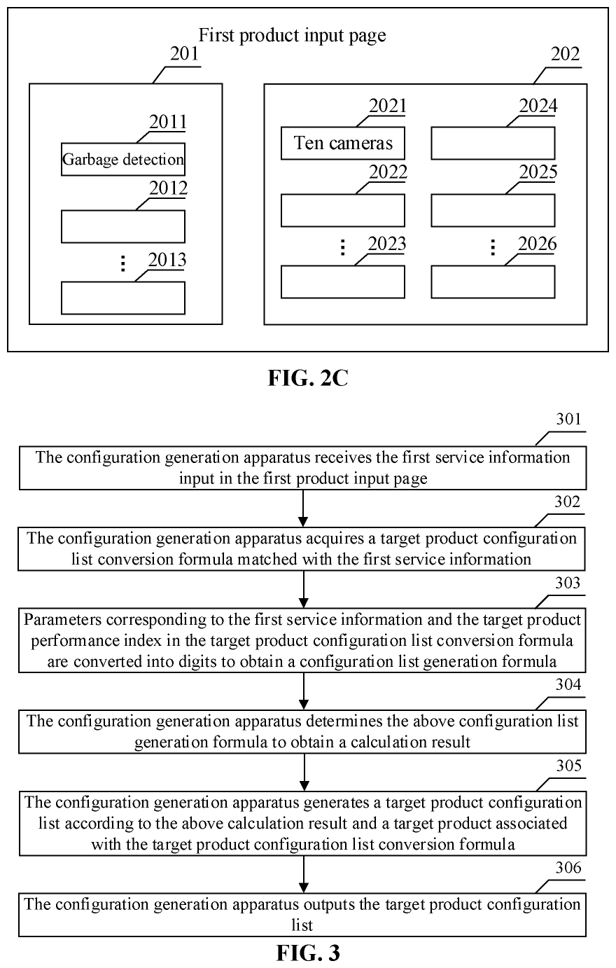

In some embodiments, the implementation of operation 101 is as follows: the configuration generation apparatus receives the first service information from the user through its running software. Herein, the configuration generation apparatus is the terminal device. In practice, the user may input the first service information to the configuration generation apparatus through an input device, such as a keyboard, a mouse or a touch screen. In some embodiments, the configuration generation apparatus receives the first service information filled in by the user through the first product input page displayed by its running software. FIG. 2A is a schematic diagram of a first product input page according to an embodiment of the disclosure. As illustrated in FIG. 2A, the first product input page includes: a service fill-in column 201 and a scenario element fill-in column 202. The service fill-in column 201 is used for filling in the service function (such as a crowd detection function). The service fill-in column 201 includes at least one fill-in column for filling in the service function. In FIG. 2, 2011, 2012, . . . , 2013 all indicate a fill-in column for filling in the service function. The scenario fill-in column 202 includes at least one fill-in column for filling in scenario elements, and these scenario elements are used for describing a service scenario (for example, the first service scenario). 2021, 2022, . . . , and 2026 are all fill-in columns for filling in the scenario elements. FIG. 2B is a sample diagram of a first product input page according to an embodiment of the disclosure. As illustrated in FIG. 2B, the service fill-in column 201 is filled with the crowd detection function (corresponding to at least one service function), and the scenario elements filled in the scenario element fill-in column 202 include two locations and four cameras. FIG. 2C is a sample diagram of another first product input page according to an embodiment of the disclosure. As illustrated in FIG. 2C, the service fill-in column 201 is filled with a garbage detection function (corresponding to at least one service function), and the scenario elements filled in the scenario element fill-in column 202 are ten cameras.

In some embodiments, the implementation of operation 101 is as follows: the configuration generation apparatus receives the first service information from the terminal device (such as a desktop computer) through a communication interface. Herein, the configuration generation apparatus is a server.

At 102, a target product configuration list is generated based on the first service information and the target product performance index.

The target product performance index includes the performance index of a target product that implements the at least one service function under the first service scenario, and the target product configuration list includes at least one of the number of the target products, the software configuration of the target products and the hardware configuration of the target products.

A possible implementation of operation 102 is as follows: a target product configuration list conversion formula is acquired, the target product configuration list conversion formula being used for determining, required to implement the at least one service function under the first service scenario, at least one of the number of the target products, the software configuration of the target products and the hardware configuration of the target products; parameters in the target product configuration list conversion formula are determined based on the first service information and the target product performance index, and the target product configuration list conversion formula is determined to obtain a calculation result; and the target product configuration list is generated according to the calculation result and the target product associated with the target product configuration list conversion formula. The configuration generation apparatus takes the first service information and the product performance index as the parameters of the target product configuration list conversion formula, so that the required number of the target products and the hardware and software configurations of the target products may be accurately determined. In some embodiments, the configuration generation apparatus may store correspondence between the above at least one service function in the first service scenario and the target product configuration list conversion formula. According to the correspondence, the target product configuration list conversion formula corresponding to the above at least one service function may be acquired. In some embodiments, the configuration generation apparatus may store or obtain a product configuration list conversion formula (for example, the target product configuration list conversion formula) corresponding to one service function in multiple service scenarios or a combination of multiple service functions. For example, the configuration generation apparatus may store a correspondence between a first service function in the first service scenario and a first product configuration list conversion formula and a correspondence between a second service function in a second service scenario and a second product configuration list conversion formula. For another example, the configuration generation apparatus may store a correspondence between a combination of a third service function and a fourth service function in the first service scenario and a certain product configuration list conversion formula.

In some embodiments, at least one parameter in the target product configuration list conversion formula is not a digit, and the configuration generation device cannot directly determine the above target product configuration list conversion formula. In some embodiments, the configuration generation apparatus may convert the parameters corresponding to the first service information and the target product performance index in the target product configuration list conversion formula into digits to obtain a configuration list generation formula; and determine the configuration list generation formula to obtain the calculation result. In some embodiments, part parameters corresponding to the first service information and the product performance index in the target product configuration list conversion formula are converted into digits by dynamic compilation to obtain a configuration list generation formula. The configuration generation apparatus replaces the parameters in the target product configuration list conversion formula with the digits by a dynamic compilation technology to obtain the configuration list generation formula, which may enhance the efficiency. For example, the target product configuration list conversion formula is as follows: (whether garbage detection is required==Yes? Math.ceil (the number of garbage detection cameras/garbage detection performance index)/2:0). Herein, the number of the garbage detection cameras (corresponding to the first service information) and the garbage detection performance index (corresponding to the product performance index) are both non-digits. The configuration list generation formula is as follows: (whether garbage detection is required==Yes? Math.ceil (10/3)/2:0). As can be seen from the example, at least one parameter in the target product configuration list conversion formula is not a digit, and the configuration generation device cannot directly determine the above target product configuration list conversion formula, but the configuration generation apparatus may directly determine the configuration list generation formula.

In some embodiments, before performing operation 102, the configuration generation apparatus may further perform the following operations that: the configuration generation apparatus outputs the above target product configuration list. For example, the configuration generation apparatus is the terminal device (such as the desktop computer), and an output device (such as a display screen) of the configuration generation apparatus displays the target product configuration list. For example, the configuration generation apparatus is the server, and the configuration generation apparatus sends the target product configuration list to the terminal device (for example, the terminal device that sends the first service information to the configuration generation apparatus).

In some embodiments, the first service information includes multiple pieces of target service information. Each of the multiple pieces of target service information includes target information for describing the target service scenario and at least one target service function. The target service scenario is a scenario where the at least one target service function is applied. The target product configuration list includes multiple sub-target product configuration lists. Each of the multiple sub-target product configuration lists includes at least one of the number of at least one sub-target product, the software configuration of the at least one sub-target product and the hardware configuration of the at least one sub-target product, and the at least one sub-target product is included in the target product. The target service scenarios corresponding to different target service information in the above multiple pieces of target service information are different. For example, the multiple pieces of target service information include first target service information to N-th target service information. The first target service information is used to describe the target information of a first target service scenario and at least one first target service function; the second target service information is used to describe the target information of a second target service scenario and at least one second target service function; . . . ; and the N-th target service information is used to describe the target information of a N-th target service scenario and at least one N-th target service function. That is to say, the first service information includes information for describing multiple different target service scenarios and at least one target service function in each target service scenario. In these embodiments, the configuration generation apparatus generates multiple sub-target product configuration lists by using the multiple pieces of target service information, which may improve the efficiency of generating the product configuration lists. In some embodiments, the target product performance index may include multiple sub-target product performance indexes. The sub-target product performance indexes include performance indexes of sub-target products that implement the at least one target service function in the target service scenario. The method may further include that: the sub-target product configuration lists are generated based on the target service information and the sub-target product performance indexes. It is to be understood that the configuration generation apparatus may generate the sub-target product configuration list based on each piece of target service information and the sub-target product performance index corresponding to the target service information. The sub-target product performance index corresponding to one piece of target service information is the performance index of a sub-target product that implements at least one service function corresponding to the target service information under the service scenario corresponding to the target service information. In these embodiments, the configuration generation apparatus may independently generate the sub-target product configuration lists based on the target service information and the sub-target product performance indexes.

In the embodiments of the disclosure, a target product configuration list is generated based on the target product performance index and the first service information input by the user, which can solve the problem of software and hardware configurations that the AI products need to meet when applied to different service scenarios, and is convenient to operate and short in time.

FIG. 3 is a flowchart of another configuration generation method according to an embodiment of the disclosure. The method flow in FIG. 3 is a refinement and perfection of the method flow in FIG. 2. As illustrated in FIG. 3, the method includes the following operations.

At operation 301, the configuration generation apparatus receives the first service information input in the first product input page.

The configuration generation apparatus receives the first service information filled in the first product input page by the user. The first service information includes first information for describing the first service scenario and the at least one service function, and the first service scenario is a scenario where the at least one service function is applied. The configuration generation apparatus is the terminal device. For example, the display screen of the configuration generation apparatus displays the first product input page, and the configuration generation apparatus receives the first service information filled in the first product input page by the user through an input device such as a keyboard, a mouse or a touch screen.

At operation 302, the configuration generation apparatus acquires the target product configuration list conversion formula matched with the first service information.

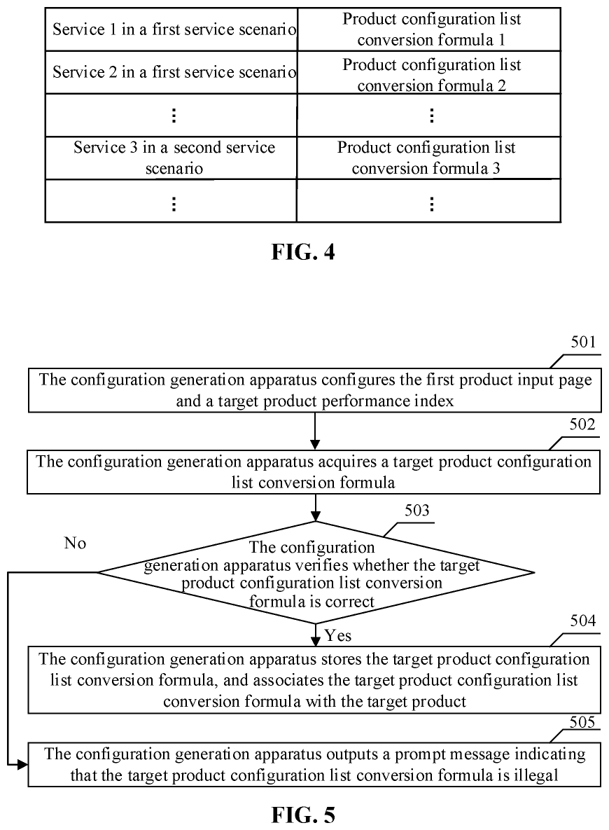

The target product configuration list conversion formula is used for determining, required to implement the at least one service function under the first service scenario, at least one of the number of the target products, the software configuration of the target products or the hardware configuration of the target products. In some embodiments, the configuration generation apparatus stores a correspondence between the above at least one service function in the first service scenario and the target product configuration list conversion formula. According to the correspondence, the target product configuration list conversion formula matched with the first service information may be acquired. In some embodiments, the configuration generation apparatus may store or obtain the correspondences between any service function in multiple service scenarios or a combination of multiple service functions and the product configuration list conversion formula (for example, the target product configuration list conversion formula), and according to these correspondences, the product configuration list conversion formula matched with multiple service information may be acquired. FIG. 4 is a diagram of correspondences between service functions and product configuration list conversion formulas according to an embodiment of the disclosure. As illustrated in FIG. 4, a service 1 (i.e., a first service) in the first service scenario corresponds to a product configuration list conversion formula 1 (for example, a first product configuration list conversion formula); a service 2 in the first service scenario corresponds to a product configuration list conversion formula 2; . . . ; and a service 3 (i.e., a second service) in a second service scenario corresponds to a product configuration list conversion formula 3 (i.e., a second product configuration list conversion formula); . . . .

At operation 303, the configuration generation apparatus converts the parameters corresponding to the first service information and the target product performance index in the target product configuration list conversion formula into digits to obtain a configuration list generation formula.

In some embodiments, the configuration generation apparatus converts the parameters corresponding to the first service information and the product performance index in the target product configuration list conversion formula into the digits by dynamic compilation to obtain the configuration list generation formula. That is to say, the parameters in the target product configuration list conversion formula are replaced with the digits by a dynamic compilation technology, so as to obtain the configuration list generation formula.

At operation 304, the configuration generation apparatus determines the configuration list generation formula and obtains the calculation result.

At operation 305, the configuration generation apparatus generates a target product configuration list according to the calculation result and the target product associated with the target product configuration list conversion formula.

The target product configuration list includes at least one of the number of the target products, the software configuration of the target products and the hardware configuration of the target products. For example, a customer needs the garbage detection function, is ready to implement this function at the gate of a community and a garbage disposal station, and is ready to put 10 cameras for monitoring. Scenario input: whether garbage detection is required=yes, camera=10 channels. After receiving the service information, the configuration generation apparatus performs the following operations: 1. the product configuration list conversion formula is acquired: (whether garbage detection is required==Yes? Math.ceil (the number of garbage detection cameras/garbage detection performance index)/2:0); 2. the product performance index is acquired: one Graphics Processing Unit (GPU) card supports parsing three cameras for garbage detection; 3. through dynamic compilation, the parameters in the product configuration list conversion formula are replaced with the digits to form a calculation formula (corresponding to the configuration list generation formula): (whether garbage detection is required==Yes? Math.ceil (10/3)/2:0); the formula determination process: according to a ternary operation rule, (whether garbage detection is required==yes) is first determined to obtain a result being true, and Math.ceil (10/3)/2 is consequently determined, and if the result is false, it is directly equal to 0; configuration list output: since the formula is associated with 2-card garbage detection server products, it is finally determined according to the formula that two 2-card garbage detection server products are required.

At 306, the configuration generation apparatus outputs the target product configuration list.

In the embodiments of the disclosure, the configuration generation apparatus may accurately and quickly generate the product configuration list according to the service information (i.e., the scenario input information).

FIG. 2 and FIG. 3 describe the method flow of generating the product configuration list by the user through the configuration generation apparatus. The method flow of the product configuration list conversion formula configured by the configuration generation apparatus is described below.

FIG. 5 is a flowchart of a method for configuring a product configuration list conversion formula according to an embodiment of the disclosure. As illustrated in FIG. 5, the method includes the following operations.

At operation 501, the configuration generation apparatus configures the first product input page and the target product performance index.

The first product input page may be understood as a scenario input form. In some embodiments, a developer (i.e., a person who developed the configuration generation method in the above-mentioned embodiments) configures the first product input page according to the actual service application scenario requirements. For example, urban management scenario: the population quantity, the service function (such as a fighting detection function) and the number of cameras are input. That is to say, the developer may configure the corresponding product input page according to the actual service application scenario requirements. In practice, the developer needs to configure different product input pages according to different service scenario settings. The first product input page is used for the user to fill in scenario information (i.e., the scenario elements) describing the first service scenario. Target product performance index: filling in is performed based on the product performance index design. For example, the product supports 10 types of event detection and 100 users to access at the same time. The developer may instantly adjust the configured product input page and product performance index according to service requirements. Compared with the user, the developer has more knowledge about how to configure software and hardware resources for a service in a certain service scenario, so the developer may configure the product input page and the product performance index according to the service scenario. In some embodiments, the configuration generation apparatus may also update the first product input page and/or the target product performance index.

At operation 502, the configuration generation apparatus acquires the target product configuration list conversion formula.

A possible implementation of operation 502 is as follows: the configuration generation apparatus receives the target product configuration list conversion formula input by the user (such as the developer) through the input device.

At operation 503, the configuration generation apparatus verifies whether the target product configuration list conversion formula is correct.

If yes, operation 504 is performed. If not, operation 505 is performed.

It is to be understood that the target product configuration list conversion formula needs to meet the operation rule, for example, the logical expression needs to use ==, if it is configured as (whether crowd detection is required=Yes? 4-channel camera/crowd analysis performance index: 0), the operation rule is violated, and the formula will be prompted to be illegal. Different from an ordinary calculator, the calculation results of various product configuration list conversion formulas configured by the configuration generation apparatus meet different product conversion requirements, such as common mathematical operators: + − * / % sqrt pow, etc.; comparison operators: > < ==, regular expression: ? :; and logical operators: && ! etc.

At operation 504, the configuration generation apparatus stores the target product configuration list conversion formula, and associates the target product configuration list conversion formula with the target product.

In some embodiments, the operation that the configuration generation apparatus associates the target product configuration list conversion with the target product may be that: the association relationship between the target product configuration list conversion formula and the target product is stored. In some embodiments, the configuration generation apparatus may associate the target product configuration list conversion formula with the target product in response to the operation of the developer. That is to say, the developer may configure the association relationship between the target product configuration list conversion formula and the target product according to actual needs. For example, a certain product configuration list conversion formula is associated with a 2-card crowd detection server product. Since the target product configuration list conversion formula is associated with the target product and the target product is a product to be applied to the first service scenario, it is to be understood as associating the product according to the service scenario. For example, the 2-card crowd detection server product is associated according to a certain scenario setting. The configuration generation apparatus stores the target product configuration list conversion formula that passed the validity verification and associates the target product configuration list conversion formula with the target product, which may ensure the correctness of passing the target product configuration list conversion formula and ensure that the product configuration list may be obtained through the target product configuration list conversion formula.

At operation 505, the configuration generation apparatus outputs a prompt message indicating that the target product configuration list conversion formula is illegal.

In the embodiments of the disclosure, the configuration generation apparatus can configure different product input pages according to different service scenario settings, and configure the product performance index according to actual conditions, so as to meet the requirement for generating product configuration lists under different service scenarios.

FIG. 1 and FIG. 3 describe the flow of implementing the configuration generation method independently by the configuration generation apparatus. The flow of jointly implementing the configuration generation method by the terminal device and the configuration generation device (for example, the server) is described below.

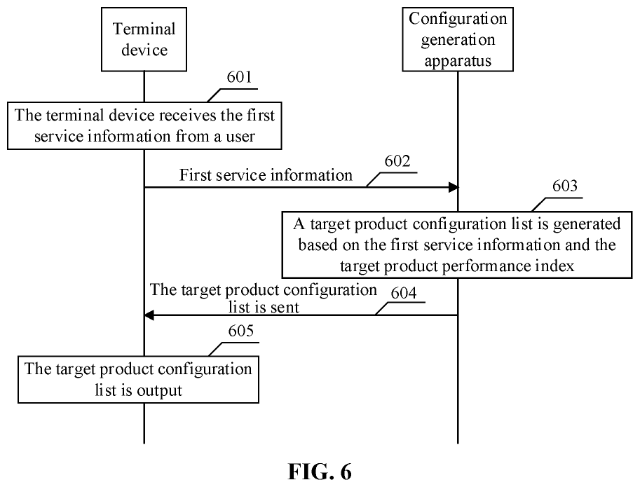

FIG. 6 is a flowchart of another configuration generation method according to an embodiment of the disclosure. As illustrated in FIG. 6, the method includes the following operations.

At operation 601, the terminal device receives the first service information from the user.

The first service information includes first information for describing the first service scenario and the at least one service function, and the first service scenario is a scenario where the at least one service function is applied. A possible implementation of operation 601 is as follows: the first service information filled in the first product input page by the user is received. For example, after the terminal device logs in to a certain web site, it opens the first product input page (a certain web page) and fills in the first service information through the first product input page.

At operation 602, the configuration generation apparatus receives the first service information from the terminal device.

The configuration generation apparatus may be a server.

At operation 603, the configuration generation apparatus generates a target product configuration list based on the first service information and the target product performance index.

The implementation of operation 603 may be the same as the implementation of operation 102.

At operation 604, the configuration generation apparatus sends the target product configuration list to the terminal device.

At operation 605, the terminal device outputs the target product configuration list.

The method flow that the configuration generation apparatus receives the first service information from the terminal device and sends the target product configuration list to the terminal device may be understood as providing the terminal device with a service of generating the product configuration list. The configuration generation apparatus may provide the service of generating the product configuration list for multiple terminal devices at the same time, and the terminal devices do not need to generate the product configuration lists by themselves.

In the embodiments of the disclosure, the configuration generation apparatus may provide the service of generating the product configuration list for the multiple terminal devices, so that the resource utilization rate is high.

FIG. 7 is a flowchart of another configuration generation method according to an embodiment of the disclosure. As illustrated in FIG. 7, the method includes the following operations.

At operation 701, the terminal device receives the first service information filled in the first product input page by the user.

At operation 702, the configuration generation apparatus receives the first service information from the terminal device.

At operation 703, the configuration generation apparatus acquires the target product configuration list conversion formula matched with the first service information.

The implementation of operation 703 may be the same as the implementation of operation 302.

At operation 704, the configuration generation apparatus converts the parameters corresponding to the first service information and the target product performance index in the target product configuration list conversion formula into digits to obtain a configuration list generation formula.

At operation 705, the configuration generation apparatus determines the above configuration list generation formula and obtains a calculation result.

At operation 706, the configuration generation apparatus generates a target product configuration list according to the calculation result and the target product associated with the target product configuration list conversion formula.

At operation 707, the configuration generation apparatus sends the target product configuration list to the terminal device.

At operation 708, the terminal device outputs the target product configuration list.

In the embodiments of the disclosure, the configuration generation apparatus may accurately and quickly generate the product configuration list according to the service information (i.e., the scenario input information).

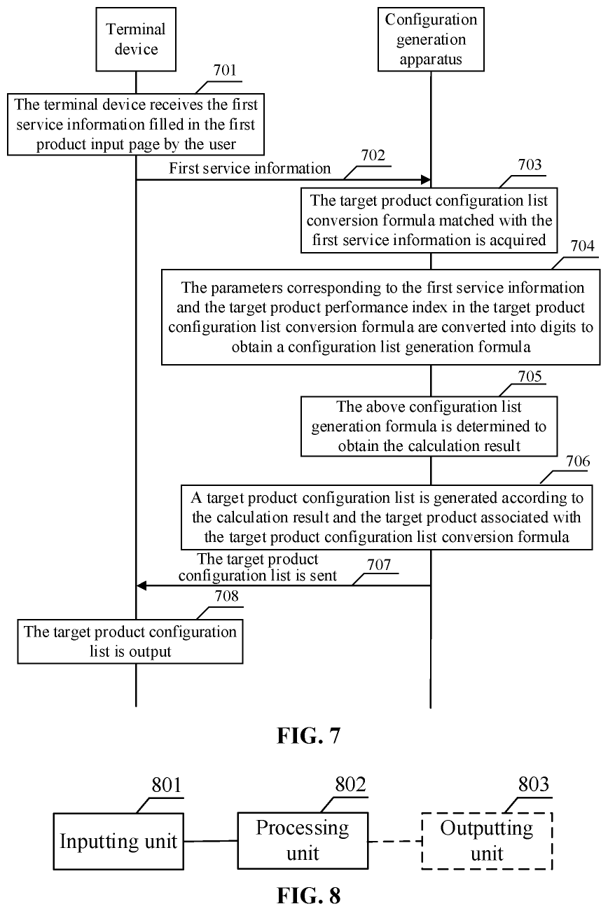

The configuration generation apparatus provided by the embodiments of the present disclosure has been described above, and the functions of each component of the configuration generation apparatus that can be used in the configuration generation method provided by the embodiments of the present disclosure are described below. FIG. 8 is a structural schematic diagram of a configuration generation apparatus according to an embodiment of the disclosure. As illustrated in FIG. 8, the configuration generation apparatus may include an input unit 801 and a processing unit 802.

The input unit 801 is configured to receive first service information, the first service information including first information for describing a first service scenario and at least one service function, and the first service scenario being a scenario where the at least one service function is applied.

The processing unit 802 is configured to generate a target product configuration list based on the first service information and a target product performance index, the target product performance index including the performance index of the target product that implements the at least one service function under the first service scenario, and the target product configuration list including at least one of the number of the target products, the software configuration of the target products and the hardware configuration of the target products.

In a possible implementation, the processing unit 802 is configured to acquire a target product configuration list conversion formula, the target product configuration list conversion formula being used for determining, required to implement the at least one service function under the first service scenario, at least one of the number of the target products, the software configuration of the target products and the hardware configuration of the target products; determine parameters in the target product configuration list conversion formula based on the first service information and the target product performance index, and determine the target product configuration list conversion formula to obtain a calculation result; and generate the target product configuration list according to the calculation result and the target product associated with the target product configuration list conversion formula.

In a possible implementation, the processing unit 802 is configured to convert the parameters corresponding to the first service information and the target product performance index in the target product configuration list conversion formula into digits to obtain a configuration list generation formula; and determine the configuration list generation formula to obtain the calculation result.

In a possible implementation, the configuration generation apparatus may further include: an output unit 803, configured to display a first product input page in response to an input instruction for selecting the first service scenario from multiple service scenarios, each of the multiple service scenarios corresponding to a product input page, and the product input pages corresponding to different service scenarios in the multiple service scenarios being different. The input unit 801 is specifically configured to receive the first service information input in the first product input page.

In an embodiment, the configuration generation apparatus is a terminal device, the input unit 801 is an input device such as a keyboard or a touch screen, and the output unit 803 is an output device such as a display. In an embodiment, the configuration generation apparatus is a server, the input unit 801 is a transmitter, and the output unit 803 is a receiver. The input unit 801 and the output unit 803 correspond to an input-output interface of the server.

In a possible implementation, the first service information includes multiple pieces of target service information. Each of the multiple pieces of target service information includes target information for describing the target service scenario and at least one target service function. The target service scenario is a scenario where the at least one target service function is applied. The target product configuration list includes multiple sub-target product configuration lists. Each of the multiple sub-target product configuration lists includes at least one of the number of at least one sub-target product, the software configuration of the at least one sub-target product and the hardware configuration of the at least one sub-target product, and the at least one sub-target product is included in the target product.

In a possible implementation, the target product performance index includes multiple sub-target product performance indexes. The sub-target product performance indexes include performance indexes of sub-target products that implement the at least one target service function in the target service scenario. The method further includes that: the sub-target product configuration lists are generated based on the target service information and the sub-target product performance indexes.

In a possible implementation, the processing unit 802 is further configured to configure the first product input page and/or the target product performance index.

In a possible implementation, the processing unit 802 is further configured to obtain the target product configuration list conversion formula; and store the target product configuration list conversion formula in the case that the target product configuration list conversion formula passes validity verification, and associate the target product configuration list conversion formula with the target product.

In a possible implementation, the processing unit 802 is further configured to acquire the target product configuration list conversion formula; and store the target product configuration list conversion formula in the case that the target product configuration list conversion formula passes the validity verification, and associate the target product configuration list conversion formula with the target product.

In a possible implementation, the processing unit 802 is further configured to update the first product input page and/or the target product performance index.

It is to be understood that division of the units in the above configuration generation apparatus is only logic function division, and the units may be completely or partially integrated to a physical entity and may also be physically separated in actual implementation. For example, the above units may be separate processing elements, and may also be integrated to the same chip for implementation. In addition, the units may also be stored in a storage element of a controller in the form of a program code, and called in a certain processing unit in a processor to execute the functions of the units. Besides, the units may be integrated together, and may also be independently implemented. The processing element herein may be an integrated circuit chip, and has a signal processing capability. During implementation, each step of the method or each unit may be completed by means of an instruction in the form of an integrated logic circuit of hardware in the processing element or software. The processing element may be a universal processor such as a Central Processing Unit (CPU), and may further be one or more integrated circuits configured to implement the above method, such as one or more Application-Specific Integrated Circuits (ASICs), or, one or more Digital Signal Processors (DSPs), or, one or more Field-Programmable Gate Arrays (FPGAs).

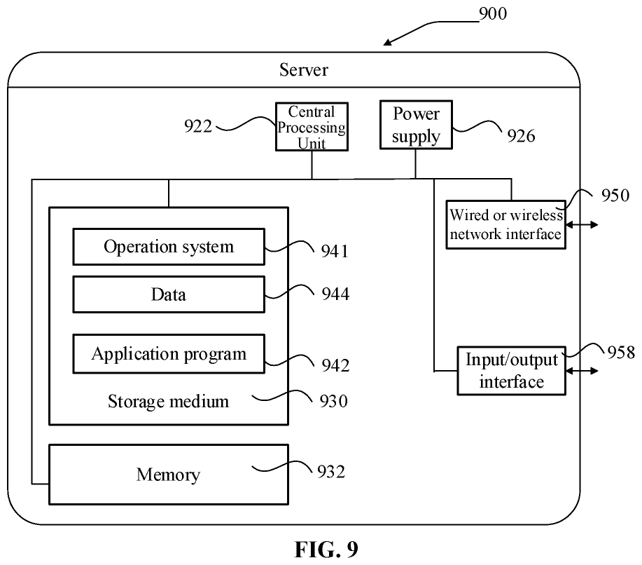

FIG. 9 is a structural schematic diagram of a server according to an embodiment of the disclosure. The server 900 may have a big difference due to different configurations or performances, and may include one or more CPUs 922 (such as one or more processors) and memory 932, and one or more storage media 930 on which application programs 942 or data 944 are stored (such as one or more massive storage devices). The memory 932 and the storage medium 930 may be for temporary storage or a persistent storage. The program stored in the storage medium 930 may include one or more modules (not illustrated in the figure); and each module may include a series of instruction operations in the server. In some embodiments, the CPU 922 may be configured to communicate with the storage medium 930, and execute, on the server 900, the series of instruction operations in the storage medium 930. The server 900 may be the configuration generation method provided by the disclosure.

The server 900 may further include one or more power supply 926, one or more wired or wireless network interfaces 950, one or more input/output interfaces 958, and/or, one or more operation systems 941, such as Windows Server™, Mac OS X™, Unix™, Linux™ and FreeBSD™.

The steps performed by the configuration generation apparatus in the above embodiments may be based on the structure of the server illustrated in FIG. 9. Specifically, the CPU 922 may implement the functions of the processing unit 802 in FIG. 8, and the input/output interface 958 may implement the functions of the input unit 801 and the output unit 803 in FIG. 8.

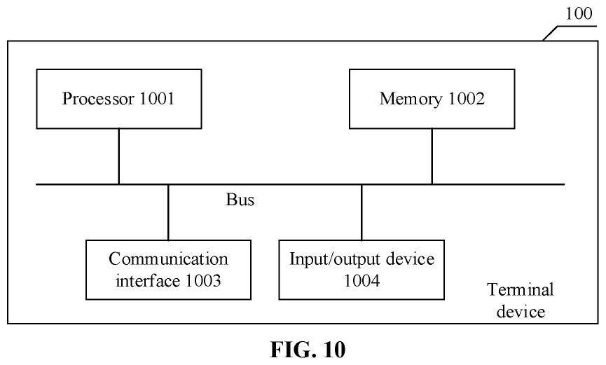

FIG. 10 is a structural schematic diagram of a terminal device according to an embodiment of the disclosure. As illustrated in FIG. 10, the terminal device 100 includes a processor 1001, a memory 1002, a communication interface 1003 and an input/output device 1004. The processor 1001, the memory 1002 and the communication interface 1003 are interconnected through a bus. The terminal device in FIG. 10 may be the configuration generation apparatus in the foregoing embodiment.

The memory 1002 includes, but is not limited to, a Random Access Memory (RAM), a Read-Only Memory (ROM), an Erasable Programmable Read-Only Memory (EPROM), or a Compact Disc Read-Only Memory (CDROM). The memory 1002 is used for related instructions and data. The communication interface 1003 is used to receive and send the data. The input/output device 1004 may include an input device such as a keyboard, a mouse or a touch screen, and an output device such as a display or a screen. The user may input an instruction, such as the first service information, to the terminal device through the input device. The output device may display the first product input page and other contents.

The processor 1001 may be one or more CPUs. In the case that the processor 1001 is one CPU, the CPU may be a single-core CPU and may also be a multi-core CPU. The steps performed by the configuration generation apparatus in the above embodiments may be based on the structure of the terminal device illustrated in FIG. 10. Specifically, the input/output device 1004 may implement the functions of the instruction input unit 801 and the output unit 803. The processor 1001 may implement the functions of the processing unit 802.

The embodiments of the disclosure provide a computer readable storage medium, and a computer program is stored on the computer readable storage medium. When performed by a processor, the computer program implements the configuration generation method provided by the above-mentioned embodiments.

The embodiments of the disclosure provide a computer program product containing an instruction. When running on a computer, the computer program product enables the computer to execute the configuration generation method provided by the above-mentioned embodiments.

### INDUSTRIAL PRACTICABILITY

The disclosure discloses a configuration generation method and apparatus, an electronic device and a storage medium. The method includes that: first service information is received, the first service information including first information for describing a first service scenario and at least one service function, and the first service scenario being a scenario where the at least one service function is applied; and a target product configuration list is generated based on the first service information and a target product performance index, the target product performance index including the performance index of the target product that implements the at least one service function under the first service scenario, and the target product configuration list including at least one of the number of the target products, the software configuration of the target products and the hardware configuration of the target products.

1. A configuration generation method, performed by a configuration generation apparatus, comprising:
receiving first service information, the first service information comprising first information for describing a first service scenario and at least one service function, and the first service scenario being a scenario where the at least one service function is applied; and
generating a target product configuration list based on the first service information and a target product performance index, the target product performance index comprising a performance index of a target product that implements the at least one service function under the first service scenario, and the target product configuration list comprising at least one of a number of target products, a software configuration of the target products, or a hardware configuration of the target products.

2. The method of claim 1, wherein generating the target product configuration list based on the first service information and the target product performance index comprises:
acquiring a target product configuration list conversion formula, the target product configuration list conversion formula being used for determining, required to implement the at least one service function under the first service scenario, at least one of the number of the target products, the software configuration of the target products, or the hardware configuration of the target products;
determining parameters in the target product configuration list conversion formula based on the first service information and the target product performance index and determining the target product configuration list conversion formula to obtain a calculation result; and
generating the target product configuration list according to the calculation result and the target product associated with the target product configuration list conversion formula.

3. The method of claim 2, wherein determining the parameters in the target product configuration list conversion formula based on the first service information and the target product performance index and determining the target product configuration list conversion formula to obtain the calculation result comprises:
converting the parameters corresponding to the first service information and the product performance index in the target product configuration list conversion formula into digits to obtain a configuration list generation formula; and
determining the configuration list generation formula to obtain the calculation result.

4. The method of claim 1, before receiving the first service information, further comprising:
displaying a first product input page in response to an input instruction for selecting the first service scenario from a plurality of service scenarios, each of the plurality of service scenarios corresponding to a product input page, and product input pages corresponding to different service scenarios in the plurality of service scenarios being different;
wherein receiving the first service information comprises:
receiving the first service information input in the first product input page.

5. The method of claim 1, wherein the first service information comprises a plurality of pieces of target service information, each of the plurality of pieces of target service information comprises target information for describing a target service scenario and at least one target service function, and the target service scenario is a scenario where the at least one target service function is applied;
wherein the target product configuration list comprises a plurality of sub-target product configuration lists, and each of the plurality of sub-target product configuration lists comprises at least one of: a number of at least one sub-target products, a software configuration of the at least one sub-target product or a hardware configuration of the at least one sub-target product, and the at least one sub-target product is comprised in the target product.

6. The method of claim 5, wherein the target product performance index comprises a plurality of sub-target product performance indexes, the sub-target product performance indexes comprises performance indexes of sub-target products that implement the at least one target service function in the target service scenario; wherein the method further comprises:
generating the sub-target product configuration lists based on the target service information and the sub-target product performance indexes.

7. The method of claim 4, further comprising:
configuring at least one of the first product input page or the target product performance index.

8. The method of claim 2, further comprising:
acquiring the target product configuration list conversion formula; and
storing the target product configuration list conversion formula and associating the target product configuration list conversion formula with the target product in case that the target product configuration list conversion formula passes a validity verification.

9. A configuration generation apparatus, comprising:
an input circuit, configured to receive first service information, the first service information comprising first information for describing a first service scenario and at least one service function, and the first service scenario being a scenario where the at least one service function is applied; and
a processing circuit, configured to generate a target product configuration list based on the first service information and a target product performance index, the target product performance index comprising a performance index of a target product that implements the at least one service function under the first service scenario, and the target product configuration list comprising at least one of a number of the target products, a software configuration of the target products or a hardware configuration of the target products.

10. The apparatus of claim 9, wherein the processing circuit is further configured to:
acquire a target product configuration list conversion formula, the target product configuration list conversion formula being used for determining, required to implement the at least one service function under the first service scenario, at least one of the number of the target products, the software configuration of the target products, or the hardware configuration of the target products;
determine parameters in the target product configuration list conversion formula based on the first service information and the target product performance index and determining the target product configuration list conversion formula to obtain a calculation result; and
generate the target product configuration list according to the calculation result and the target product associated with the target product configuration list conversion formula.

11. The apparatus of claim 10, wherein the processing circuit is further configured to:
convert the parameters corresponding to the first service information and the product performance index in the target product configuration list conversion formula into digits to obtain a configuration list generation formula; and
determine the configuration list generation formula to obtain the calculation result.

12. The apparatus of claim 9, further comprising:
an output circuit, configured to display a first product input page in response to an input instruction for selecting the first service scenario from a plurality of service scenarios, each of the plurality of service scenarios corresponding to a product input page, and product input pages corresponding to different service scenarios in the plurality of service scenarios being different;
wherein the input circuit is further configured to:
receiving the first service information input in the first product input page.

13. The apparatus of claim 9, wherein the first service information comprises a plurality of pieces of target service information, each of the plurality of pieces of target service information comprises target information for describing a target service scenario and at least one target service function, and the target service scenario is a scenario where the at least one target service function is applied;
wherein the target product configuration list comprises a plurality of sub-target product configuration lists, and each of the plurality of sub-target product configuration lists comprises at least one of: a number of at least one sub-target products, a software configuration of the at least one sub-target product or a hardware configuration of the at least one sub-target product, and the at least one sub-target product is comprised in the target product.

14. The apparatus of claim 13, wherein the target product performance index comprises a plurality of sub-target product performance indexes, the sub-target product performance indexes comprises performance indexes of sub-target products that implement the at least one target service function in the target service scenario; wherein the processing circuit is further configured to:
generate the sub-target product configuration lists based on the target service information and the sub-target product performance indexes.

15. The apparatus of claim 12, wherein the processing circuit is further configured to:
configure at least one of the first product input page or the target product performance index.

16. The apparatus of claim 10, wherein the processing circuit is further configured to:
acquire the target product configuration list conversion formula; and
store the target product configuration list conversion formula and associating the target product configuration list conversion formula with the target product in case that the target product configuration list conversion formula passes a validity verification.

17. A non-transitory computer readable storage medium having stored therein a computer program, wherein the computer program comprises a program instruction that when executed by a processor, causes the processor to execute a configuration generation method, wherein the method comprises:
receiving first service information, the first service information comprising first information for describing a first service scenario and at least one service function, and the first service scenario being a scenario where the at least one service function is applied; and
generating a target product configuration list based on the first service information and a target product performance index, the target product performance index comprising a performance index of a target product that implements the at least one service function under the first service scenario, and the target product configuration list comprising at least one of a number of target products, a software configuration of the target products, or a hardware configuration of the target products.

18. The non-transitory computer readable storage medium of claim 17, wherein generating the target product configuration list based on the first service information and the target product performance index comprises:
acquiring a target product configuration list conversion formula, the target product configuration list conversion formula being used for determining, required to implement the at least one service function under the first service scenario, at least one of the number of the target products, the software configuration of the target products, or the hardware configuration of the target products;
determining parameters in the target product configuration list conversion formula based on the first service information and the target product performance index and determining the target product configuration list conversion formula to obtain a calculation result; and
generating the target product configuration list according to the calculation result and the target product associated with the target product configuration list conversion formula.

19. The non-transitory computer readable storage medium of claim 18, wherein determining the parameters in the target product configuration list conversion formula based on the first service information and the target product performance index and determining the target product configuration list conversion formula to obtain the calculation result comprises:
converting the parameters corresponding to the first service information and the product performance index in the target product configuration list conversion formula into digits to obtain a configuration list generation formula; and
determining the configuration list generation formula to obtain the calculation result.

20. The non-transitory computer readable storage medium of claim 17, before receiving the first service information, the method further comprising:
displaying a first product input page in response to an input instruction for selecting the first service scenario from a plurality of service scenarios, each of the plurality of service scenarios corresponding to a product input page, and product input pages corresponding to different service scenarios in the plurality of service scenarios being different;
wherein receiving the first service information comprises:
receiving the first service information input in the first product input page.
